(19) United States
(12) Patent Application Publication
(10) Pub. No.: US 2023/0271339 A1
(43) Pub. Date: Aug. 31, 2023

(54) Gripping Cushion Assembly

(71) Applicant: Jennifer Bruner, Auburn, CA (US)

(72) Inventor: Jennifer Bruner, Auburn, CA (US)

(21) Appl. No.: 17/682,434

(22) Filed: Feb. 28, 2022

(51) Int. Cl. B26B 19/38

(52) U.S. Cl. CPC B26B 19/3813; B26B 19/3853

(57) ABSTRACT

A gripping cushion device for enhancing comfort while employing an electric clipper includes a cushion that has a concavely arcuate shape such that the cushion defines a parabola. In this way the cushion can be positioned around a handle of an electric clipper. The cushion is comprised of a resiliently compressible material to enhance comfort for a user employing the electric clipper.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to cushion devices and more particularly pertains to a new cushion device for enhancing comfort while employing an electric clipper. The device includes a cushion that is shaped to define a saddle which can conform to the handle of an electric clipper. The cushion has a concavely arcuate outer surface to accommodate the structure of a user's hand.

### (2) Description of Related Art Including Information Disclosed Under 37 CFR 1.97 and 1.98

The prior art relates to cushion devices including a hand cushion which includes a plurality of finger holes. The prior art discloses a contoured grip for a handle of a tool. The prior art discloses a grip for an electric clipper which includes a handle for insertably receiving a user's fingers. The prior art discloses an ergonomic grip for a paint brush that includes a handle portion for gripping and a support portion for receiving a handle of the paint brush. The prior art discloses a cylindrical grip for cushioning a handle of a salon tool. The prior art discloses a glove that is positionable around a handle of an electric clipper.

### (h) BRIEF SUMMARY OF THE INVENTION

An embodiment of the disclosure meets the needs presented above by generally comprising a cushion that has a concavely arcuate shape such that the cushion defines a parabola. In this way the cushion can be positioned around a handle of an electric clipper. The cushion is comprised of a resiliently compressible material to enhance comfort for a user employing the electric clipper.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a gripping cushion assembly according to an embodiment of the disclosure.

FIG. 2 is a bottom perspective view of an embodiment of the disclosure.

FIG. 3 is a front view of an embodiment of the disclosure.

FIG. 4 is a left side phantom view of an embodiment of the disclosure.

FIG. 5 is a front perspective view of an embodiment of the disclosure.

### (j) DETAILED DESCRIPTION OF THE INVENTION

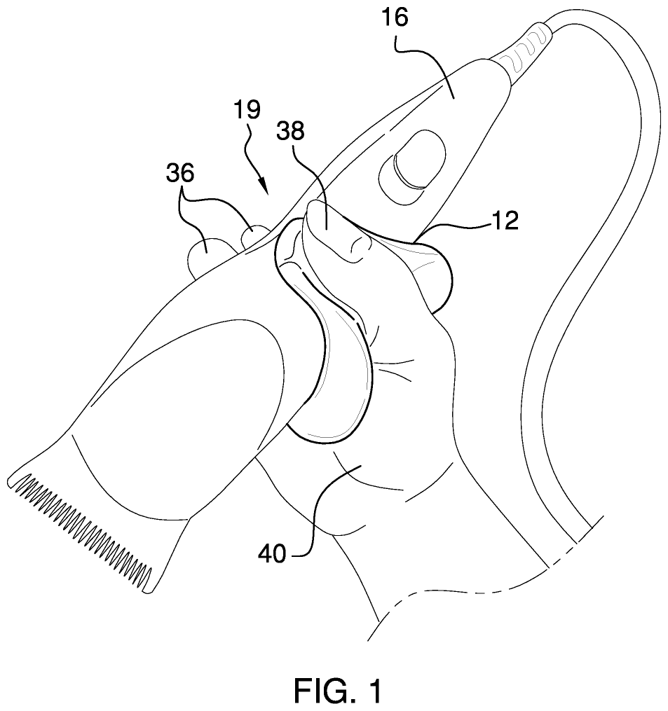

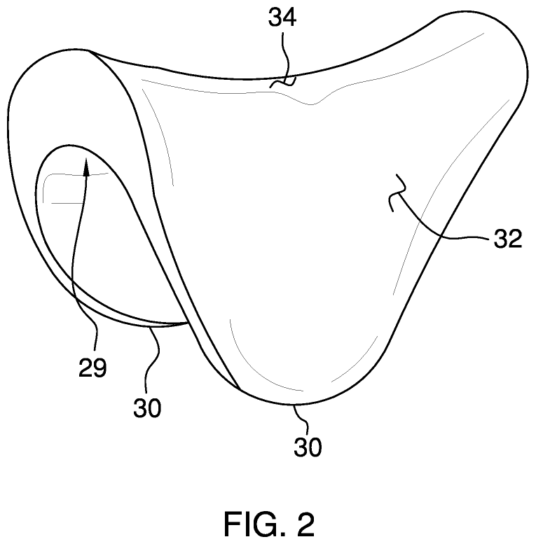

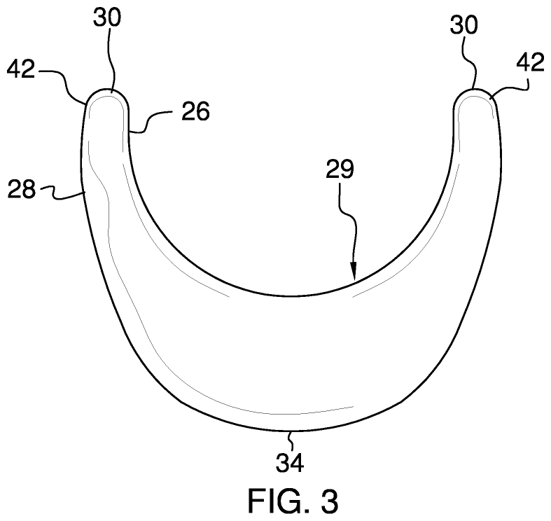

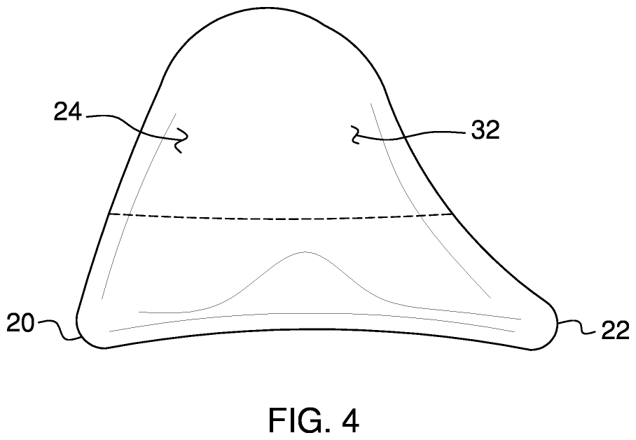

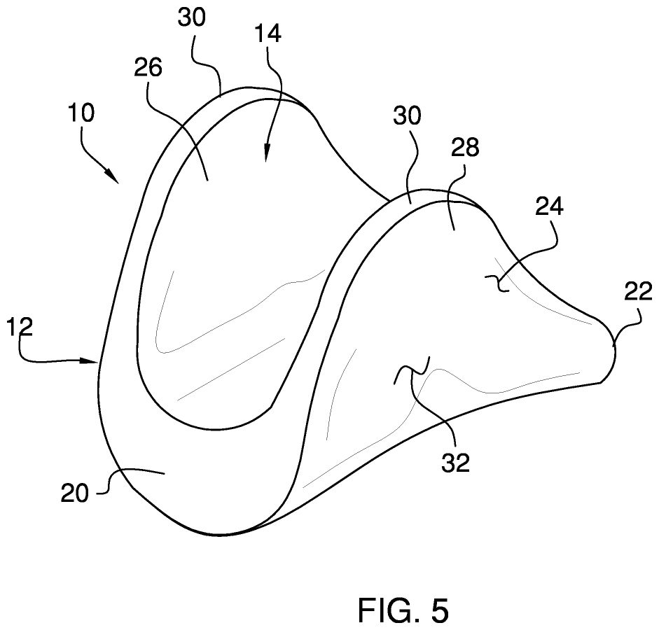

With reference now to the drawings, and in particular to FIGS. 1 through 5 thereof, a new cushion device embodying the principles and concepts of an embodiment of the disclosure and generally designated by the reference numeral 10 will be described.

As best illustrated in FIGS. 1 through 5, the gripping cushion assembly 10 generally comprises a cushion 12 which has a concavely arcuate shape such that the cushion 12 defines a saddle 14. In this way the cushion 12 can be positioned around a handle 16 of an electric clipper 19. The electric clipper 19 may be an electric clipper of any conventional design that is employed in a barber shop, for example, for trimming hair. The cushion 12 is comprised of a resiliently compressible material to enhance comfort for a user 18 employing the electric clipper 19.

The cushion 12 has a front end 20, a back end 22 and an outer surface 24 extending between the front end 20 and the back end 22, and the outer surface 24 has a top side 26 and a bottom side 28. The top side 26 is concavely arcuate with respect to the bottom side 28 such that the top side 26 defines a parabola 29. The bottom side 28 is substantially co-arcuate with the top side 26 such that the bottom side 28 defines a pair of horns 30 each extending upwardly along opposite sides of the parabola 29 defined by the top side 26. Furthermore, the bottom side 28 defines an outwardly facing surface 32 of each of the horns 30 and the bottom side 28 defines a lower surface 34 of the saddle 14 defined by the cushion 12.

The outwardly facing surface 32 of each of the horns 30 is concavely arcuate between the front end 20 and the back end 22 of the cushion 12. In this way the outwardly facing surface 32 of each of the horns 30 can accommodate respective ones of the user's fingers 36 and the user's thumb 38 when the user 18 grips the cushion 12. The lower surface 34 of the saddle 14 is concavely arcuate along an axis extending between the front end 20 and the back end 22 of the cushion 12. In this way the lower surface 34 of the saddle 14 can accommodate a palm of the user's hand 40 when the user 18 grips the cushion 12.

The front end 20 of the cushion 12 slopes forwardly between an upper threshold 42 of each of the horns 30 and the lower surface 34 of the saddle 14. The back end 22 of the saddle 14 slopes rearwardly between the upper threshold 42 of each of the horns 30 and the lower surface 34 of the saddle 14. The front end 20 may slope a distance of approximately 1.0 inches to 2.0 inches forwardly with respect to a central, vertical axis of the horns 30. The back end 22 may slope a distance of approximately 2.0 inches to 3.0 inches with respect to the central, vertical axis of the horns 30. Furthermore, the back end 22 is concavely arcuate between the upper threshold 42 of each of the horns 30 and the lower surface of the saddle 14.

In use, the cushion 12 is positioned on the handle 16 of the electric clipper 19 at a location along the handle 16 that suits the user's 18 preference. In this way the cushion 12 can be gripped when the user 18 wishes to employ the electric clipper 19. The structure of the cushion 12 more effectively conforms to the structure of the user's 18 hand as compared to the structure of the handle 16 of the electric clipper 19. Additionally, the resiliently compressible property of the cushion 12 reduces vibration that is imparted into the user's hand 40 when the user 18 employs the electric clipper 19. In this way the cushion 12 reduces fatigue and stress with respect to the user's hand 40 while the user 18 employs the electric clipper 19.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A gripping cushion device for conforming to an electric clipper thereby enhancing comfort for a user, said device comprising:
a cushion having a concavely arcuate shape such that said cushion defines a parabola wherein said cushion is configured to be positioned at a selectable position around a handle of an electric clipper, said cushion being comprised of a resiliently compressible material wherein said cushion is configured to enhance comfort for a user employing the electric clipper.

2. The device according to claim 1, wherein said cushion has a front end, a back end and an outer surface extending between said front end and said back end, said outer surface having a top side and a bottom side, said top side being concavely arcuate with respect to said bottom side such that said top side defines a parabola, said bottom side being co-arcuate with said top side such that said bottom side defines a pair of horns each extending upwardly along opposite sides of said parabola defined by said top side.

3. The device according to claim 2, wherein said bottom side defines an outwardly facing surface of each of said horns, said outwardly facing surface of each of said horns being concavely arcuate between said front end and said back end of said cushion wherein said outwardly facing surface of each of said horns is configured to accommodate respective ones of the user's fingers and the user's thumb when the user grips said cushion.

4. The device according to claim 2, wherein said bottom side defines a lower surface of said saddle defined by said cushion, said lower surface of said saddle being concavely arcuate along an axis extending between said front end and said back end of said cushion wherein said lower surface of said saddle is configured to accommodate a palm of the user's hand when the user grips said cushion.

5. The device according to claim 4, wherein said front end of said saddle slopes forwardly between an upper threshold of each of said horns and said lower surface of said saddle.

6. The device according to claim 4, wherein said back end of said saddle slopes rearwardly between said upper threshold of each of said horns and said lower surface of said saddle.

7. The device according to claim 4, wherein said back end is concavely arcuate between said upper threshold of each of said horns and said lower surface of said saddle.

8. A gripping cushion device for conforming to an electric clipper thereby enhancing comfort for a user, said device comprising:
a cushion having a concavely arcuate shape such that said cushion defines a saddle wherein said cushion is configured to be positioned at a selectable position around a handle of an electric clipper, said cushion being comprised of a resiliently compressible material wherein said cushion is configured to enhance comfort for a user employing the electric clipper, said cushion having a front end, a back end and an outer surface extending between said front end and said back end, said outer surface having a top side and a bottom side, said top side being concavely arcuate with respect to said bottom side such that said top side defines a parabola, said bottom side being substantially co-arcuate with said top side such that said bottom side defines a pair of horns each extending upwardly along opposite sides of said parabola defined by said top side, said bottom side defining an outwardly facing surface of each of said horns, said bottom side defining a lower surface of said saddle defined by said cushion, said outwardly facing surface of each of said horns being concavely arcuate between said front end and said back end of said cushion wherein said outwardly facing surface of each of said horns is configured to accommodate respective ones of the user's fingers and the user's thumb when the user grips said cushion, said lower surface of said saddle being concavely arcuate along an axis extending between said front end and said back end of said cushion wherein said lower surface of said saddle is configured to accommodate a palm of the user's hand when the user grips said cushion, said front end of said saddle sloping forwardly between an upper threshold of each of said horns and said lower surface of said saddle, said back end of said saddle sloping rearwardly between said upper threshold of each of said horns and said tower surface of said saddle, said back end being concavely arcuate between said upper threshold of each of said horns and said lower surface of said saddle.

9. A gripping cushion system for conforming to an electric clipper thereby enhancing comfort for a user, said system comprising:
an electric clipper having a handle, said handle having an outer surface, said outer surface being substantially arcuate about a longitudinal axis of said handle; and
a cushion having a concavely arcuate shape such that said cushion defines a saddle thereby facilitating said cushion to be positioned at a selectable position around said handle of said electric clipper, said cushion being comprised of a resiliently compressible material wherein said cushion is configured to enhance comfort for a user employing the electric clipper, said cushion having a front end, a back end and an outer surface extending between said front end and said back end, said outer surface having a top side and a bottom side, said top side being concavely arcuate with respect to said bottom side such that said top side defines a parabola, said bottom side being substantially co-arcuate with said top side such that said bottom side defines a pair of horns each extending upwardly along opposite sides of said parabola defined by said top side, said bottom side defining are outwardly facing surface of each of said horns, said bottom side defining a lower surface of said saddle defined by said cushion, said outwardly facing surface of each of said horns being concavely arcuate between said front end and said back end of said cushion wherein said outwardly fixing surface of each of said horns is configured to accommodate respective ones of the user's fingers and the user's thumb when the user grips said cushion, said lower surface of said saddle being concavely arcuate along an axis extending between said front end and said back end of said cushion Wherein said lower surface of said saddle is configured to accommodate a palm of the user's hand when the user grips said cushion, said front end sloping forwardly between an upper threshold of each of said horns and said lower surface of said saddle, said back end sloping rearwardly between said upper threshold of each of said horns and said lower surface of said saddle, said back end being concavely arcuate between said upper threshold of each of said horns and said lower surface of said saddle.
